(19) United States
(12) Patent Application Publication
(10) Pub. No.: US 2014/0208030 A1
(43) Pub. Date: Jul. 24, 2014

(54) INFORMATION PROCESSING APPARATUS AND CONTROL METHOD OF INFORMATION PROCESSING APPARATUS

(71) Applicant: FUJITSU LIMITED, Kawasaki-shi (JP)

(72) Inventors: Hideki SAKATA, Kawasaki (JP); Go SUGIZAKI, Machida (JP); Naoya ISHIMURA, Tama (JP)

(73) Assignee: FUJITSU LIMITED, Kawasaki-shi (JP)

(21) Appl. No.: 14/220,270

(22) Filed: Mar. 20, 2014

Related U.S. Application Data
(63) Continuation of application No. PCT/JP2011/071621, filed on Sep. 22, 2011.

(51) Int. Cl. G06F 12/08

(52) U.S. Cl. CPC G06F 12/084
USPC 711/119

(57) ABSTRACT

An information processing apparatus including a plurality of mutually connected system boards, wherein each of the system boards includes: a plurality of processors; and a plurality of memories each of which stores data and directory information corresponding to the data, and corresponds to any one of the processors, and wherein each of the plurality of processors, upon receiving a read request for data stored in a memory corresponding to the own processor from another processor, performs an exclusive logical sum operation on identification information included in the read request and identifying the another processor and a check bit included in the directory information and identifying a processor which holds target data of the read request, increments a count value included in the directory information and indicating the number of processors which hold the target data, and sets presence information included in the directory information and indicating a system board which includes the another processor.

### CROSS-REFERENCE TO RELATED APPLICATION

This application is a continuation application of International Application PCT/JP2011/071621 filed on Sep. 22, 2011 and designated the U.S., the entire contents of which are incorporated herein by reference.

### FIELD

The embodiment discussed herein is directed to an information processing apparatus and a control method of the information processing apparatus.

### BACKGROUND

There is an NUMA (Non-Uniform Memory Access) type of a memory system employed in a multiprocessor as an information processing apparatus. Since the memory is distributed and connected to processors as processors, this system is capable of distributed processing of memory access unlike a memory system which is unitarily managed. Accordingly, there is an advantage that even if the number of processors is increased, the memory system is less likely to become a bottle neck.

There is a directory system for control in order to keep cache coherence that is conformity between a cache memory included in each processor and a main memory in such a memory system. This is a system in which a region called directory is prepared for each data block in management units and, by referring to the directory, the status of the data block, namely, whether the data block is shared among processors, whether there is a processor having an exclusive right, which processor has the exclusive right and so on can be recognized.

For example, to suppress an increase in physical amount of the directory in a large scale configuration, a coarse bit scheme with the management unit changed from a CPU (Central Processing System) to a CPU group is suggested (see, for example, Non-Patent Document 1).

However, in this scheme, there is a problem in which when a CPU has made an incorrect response, the breakdown point cannot be identified. For example, in the case where four CPUs in the same group hold the data block and when only three CPUs have made reports of holding, it can be found that the number of reports of holding is incorrect, but which of the CPUs is a suspect CPU that is suspected to have broken down cannot be determined in this scheme.

A computer system required for RAS (Reliability, Availability, Serviceability), upon detecting an irreparable breakdown, separates a suspect point and restarts to thereby degenerate, and tries to continue processing. For this end, it is necessary to identify the breakdown point.

Further, a multiprocessor device is known in which in the case of a shared state where the value on the cache memory and the value on the main memory are the same, the status of registration on the cache memory is stored in a directory memory in cache line units composed of a plurality of sub-lines (see, for example, Patent Document 1).

Patent Document 1: Japanese Laid-open Patent Publication No. 2007-4834

Non-Patent Document 1: Gupta et al, “Reducing memory and traffic requirements for scalable directory-based cache coherence schemes” In

Proceedings of International Conference on Parallel Processing, volume I, pp. 312-321, 1990

### SUMMARY

According to an aspect of the embodiment, an information processing apparatus is an information processing apparatus including a plurality of mutually connected system boards, wherein each of the system boards includes: a plurality of processors; and a plurality of memories each of which stores data and directory information corresponding to the data, and corresponds to any one of the processors, and wherein each of the plurality of processors, upon receiving a read request for data stored in a memory corresponding to the own processor from another processor, performs an exclusive logical sum operation on identification information included in the read request and identifying the another processor and a check bit included in the directory information and identifying a processor which holds target data of the read request, increments a count value included in the directory information and indicating the number of processors which hold the target data, sets presence information included in the directory information and indicating a system board which includes the another processor, and outputs the target data to the another processor which has issued the read request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a memory distribution type multiprocessor system according to an embodiment;

FIG. 2 is a diagram illustrating a configuration example of a system board in FIG. 1;

FIG. 3 is a diagram illustrating a configuration example of a central processing unit in FIG. 2;

FIG. 4 is a chart illustrating examples of data, directory information, and error detection correction (ECC) information stored in a memory;

FIG. 5A is a chart illustrating a configuration example of directory information according to a comparative example;

FIG. 5B is a chart illustrating a configuration example of directory information according to this embodiment;

FIG. 6 is a chart illustrating the correspondence between a central processing unit number and a specific bit sequence;

FIG. 7 is a chart illustrating an example of a case where a central processing unit in a system board reads data in a memory in another system board;

FIG. 8 is a chart illustrating the example of the case where the central processing unit in the system board reads the data in the memory in the other system board;

FIG. 9 is a chart illustrating an example of a case where a central processing unit in the system board reads the data in the memory in the other system board;

FIG. 10 is a chart illustrating the example of the case where the central processing unit in the system board reads the data in the memory in the other system board;

FIG. 11 is a chart illustrating an example of a case where a central processing unit in the system board reads the data in the memory in the other system board;

FIG. 12 is a chart illustrating the example of the case where the central processing unit in the system board reads the data in the memory in the other system board;

FIG. 13 is a chart illustrating an example where a central processing unit issues an acquisition request for an exclusive right for writing data;

FIG. 14 is a chart illustrating the example where the central processing unit issues the acquisition request for the exclusive right for writing data;

FIG. 15 is a chart illustrating the example where the central processing unit issues the acquisition request for the exclusive right for writing data;

FIG. 16 is a chart illustrating the example where the central processing unit issues the acquisition request for the exclusive right for writing data;

FIG. 17 is a chart illustrating the example where the central processing unit issues the acquisition request for the exclusive right for writing data;

FIG. 18 is a chart illustrating the example where the central processing unit issues the acquisition request for the exclusive right for writing data;

FIG. 19 is a chart illustrating another example where a central processing unit issues an acquisition request for an exclusive right for writing data;

FIG. 20 is a chart illustrating the other example where the central processing unit issues the acquisition request for the exclusive right for writing data;

FIG. 21 is a chart illustrating the other example where the central processing unit issues the acquisition request for the exclusive right for writing data;

FIG. 22 is a chart illustrating the other example where the central processing unit issues the acquisition request for the exclusive right for writing data;

FIG. 23 is a chart illustrating the other example where the central processing unit issues the acquisition request for the exclusive right for writing data;

FIG. 24 is a chart illustrating the other example where the central processing unit issues the acquisition request for the exclusive right for writing data;

FIG. 25 is a flowchart illustrating an example of update processing on directory information when a read request or a write request (an exclusive right acquisition request) is issued from a central processing unit;

FIG. 26 is a flowchart illustrating a processing example of an invalidation request in FIG. 25; and

FIG. 27 is a flowchart illustrating an example of update processing on directory information in processing of write back or flush back.

### DESCRIPTION OF EMBODIMENTS

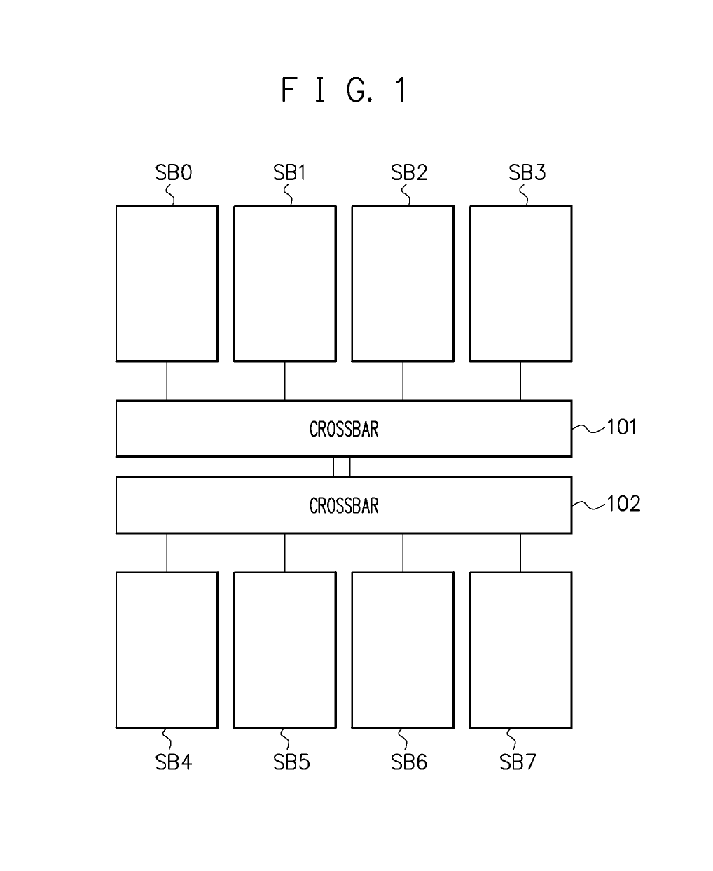

FIG. 1 is a diagram illustrating a configuration example of a memory distribution type multiprocessor system as an information processing apparatus according to an embodiment. Eight system boards SB0 to SB7 are mutually connected via crossbars 101 and 102. The crossbar 101 is connected to four system boards SB0 to SB3. The crossbar 102 is connected to four system boards SB4 to SB7. The crossbars 101 and 102 are mutually connected to perform communication among the system boards SB0 to SB7.

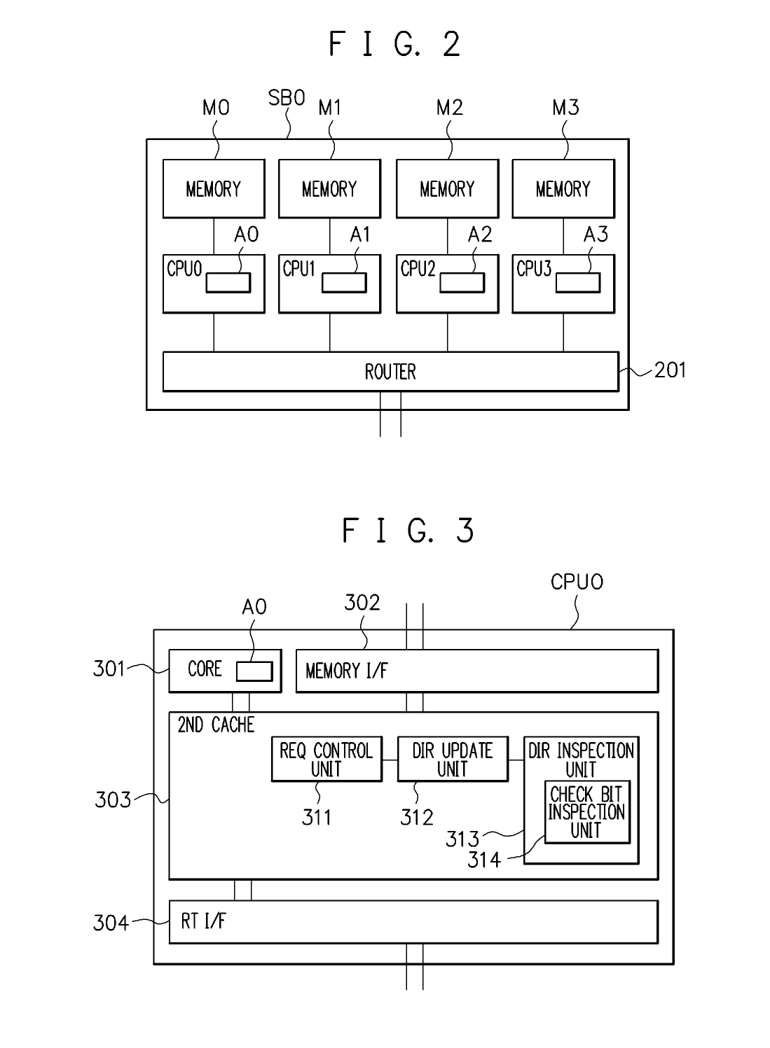

FIG. 2 is a diagram illustrating a configuration example of the system board SB0 in FIG. 1. The system board SB0 has four central processing units CPU0 to CPU3, four memories M0 to M3 constituting a main memory, and a router 201 for performing communication in the system board SB0. The four memories M0 to M3 are in a distributed memory configuration in which they are correspondingly connected to the four central processing units CPU0 to CPU3 respectively. The router 201 is connected to the four central processing units CPU0 to CPU3 and performs communication among the central processing units CPU0 to CPU3 in the system board SB0. For example, the central processing unit CPU0 requests for access to the other central processing units CPU1 to CPU3 through the router 201 and thereby can access the memories M1 to M3 connected to the central processing units CPU1 to CPU3. The central processing units CPU0 to CPU3 have respective primary cache memories A0 to A3.

Similarly to the system board SB0, the system board SB1 has four central processing units CPU4 to CPU7, four memories M4 to M7, and a router 201. The system board SB2 has four central processing units CPU8 to CPU11, four memories M8 to M11, and a router 201. The system board SB3 has four central processing units CPU12 to CPU15, four memories M12 to M15, and a router 201. The system board SB4 has four central processing units CPU16 to CPU19, four memories M16 to M19, and a router 201. The system board SB5 has four central processing units CPU20 to CPU23, four memories M20 to M23, and a router 201. The system board SB6 has four central processing units CPU24 to CPU27, four memories M24 to M27, and a router 201. The system board SB7 has four central processing units CPU28 to CPU31, four memories M28 to M31, and a router 201. For example, the central processing unit CPU0 requests for access to the other central processing units CPU4 to CPU31 of the other system boards SB1 to SB7 through the router 201 and the crossbars 101, 102 and thereby can access the memories M4 to M31 connected to the other central processing units CPU4 to CPU31.

FIG. 3 is a diagram illustrating a configuration example of the central processing unit CPU0 in FIG. 2. The central processing unit CPU0 as a processor has a core unit 301, a memory interface 302, a secondary cache memory section 303, and a router interface 304. The core unit 301 has the primary cache memory A0 and performs various kinds of processing. The memory interface 302 is connected to the external memory M0 and inputs/outputs information from/to the memory M0. The router interface 304 is connected to the external router 201 and inputs/outputs information from/to the router 201. The secondary cache memory section 303 has a request control unit 311, a directory information update unit 312, and a directory information inspection unit 313. The directory information inspection unit 313 has a check bit inspection unit 314. The request control unit 311 conducts control on the basis of a request signal from the core unit 301 or the router 201 to make a response. The directory information update unit 312 manages directory information in response to a response signal from the memory M0 or the router 201. The directory information inspection unit 313 inspects the directory information. The check bit inspection unit 314 inspects a check bit in the directory information.

The secondary cache memory section 303 executes, at the request control unit 311, an instruction from the core unit 301 or instructions from the core units 301 of the other central processing units CPU4 to CPU31 via the router interface 304, and accesses the memory M0 via the memory interface 302. The directory information is stored in the memories M0 to M31 together with data corresponding thereto. The central processing unit CPU0 inspects, at the directory information inspection unit 313, the directory information accompanying the data read from the memory M0, and outputs an invalidation request or transfers the data to the other central processing units CPU1 to CPU31 as necessary. Further, in the case where the data holding status in the central processing units CPU0 to CPU31 is changed, the directory information update unit 312 updates the directory information on the memory M0. The check bit inspection unit 314 updates and inspects the check bit in the directory information. Note that the other central processing units CPU1 to CPU31 also have the same configuration as that of the central processing unit CPU0.

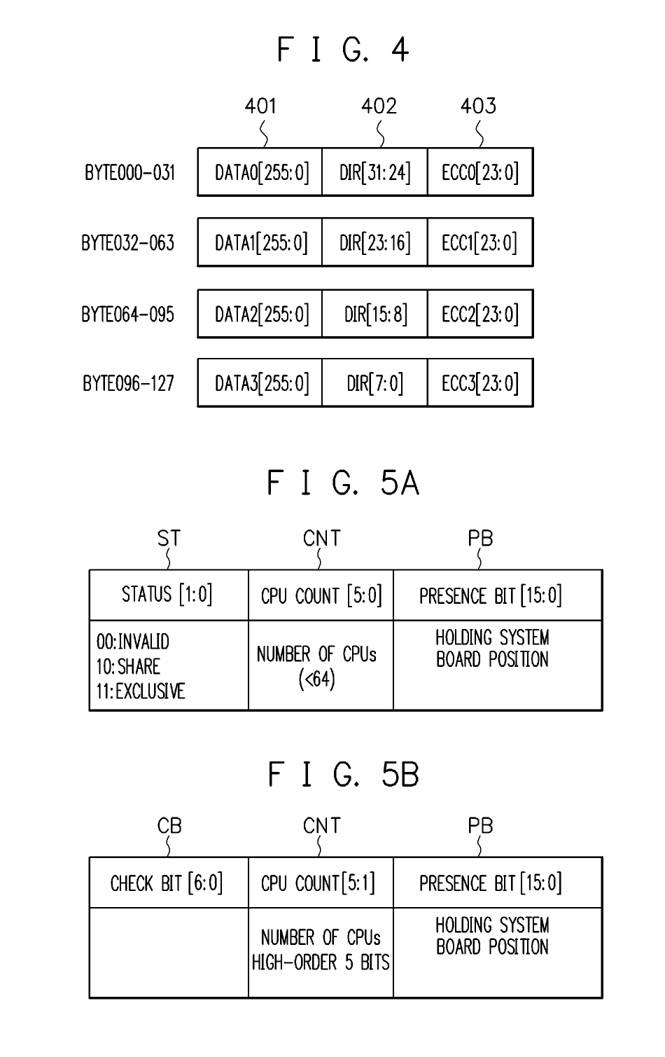

FIG. 4 is a chart illustrating examples of data 401, directory information 402, and error detection correction (ECC) information 403 stored in each of the memories M0 to M31. Each of the central processing units CPU0 to CPU31 reads and writes information in 128-byte units illustrated in FIG. 4 from/to each of the memories M0 to M31. The 128-byte information has four sets of 32-byte information. Each set of 32-byte information has the data 401, the directory information 402, and the ECC information 403. The ECC information 403 is information for error detection correction for the data 401 and the direction information 402.

For example, in each 32 bytes, the data 401 is 256 bits, the directory information 402 is 8 bits, and the ECC information 403 is 24 bits. Accordingly, when a data block is managed for each 128 bytes, the directory information 402 of 8 bits×4=32 bits can be secured. In this embodiment, 28 bits of the 32 bits of the directory information 402 are used. Therefore, the 128 bytes illustrated in FIG. 4 is the minimum management unit.

FIG. 5A is a chart illustrating a configuration example of directory information 402 according to a comparative example. The directory information 402 has a status ST of 2 bits, a central processing unit count value CNT of 6 bits, and a presence bit (presence information) PB of 16 bits. The status ST indicates the state of the data 401 corresponding thereto. “00” of the status ST indicates that the data 401 is not held in the other central processing units except the own central processing unit. “10” of the status ST indicates that the data 401 is in a shared state and the data 401 is held in the other central processing units. “11” of the status ST indicates that the data 401 is held in the other central processing unit having an exclusive right for the data 401. The central processing unit count value CNT indicates the number of the central processing units (but except the own central processing unit) which hold the data 401 corresponding to the own directory information 402. The presence bit PB is bits for identifying the system board including the central processing units (but except the own central processing unit) which hold the data 401 corresponding to the own directory information 402.

FIG. 5B is a chart illustrating a configuration example of directory information 402 according to this embodiment. The directory information 402 has a check bit CB of 7 bits, a central processing unit count value CNT of 5 bits, and a presence bit PB of 16 bits. The check bit CB is bits for identifying the central processing units which hold the data 401 corresponding to the own directory information 402, and has a number of bits smaller than the total number of the central processing units. The central processing unit count value CNT indicates the number of the central processing units (except the own central processing unit) which hold the data 401 corresponding to the own directory information 402. The presence bit PB is bits for identifying the system board including the central processing units (except the own central processing unit) which hold the data 401 corresponding to the own directory information 402. The presence bit PB has 16 bits for identifying the 16 system boards SB0 to SB15.

Note that the central processing unit count value CNT may be the information of 6 bits indicating the number of the central processing units (except the own central processing unit) which hold the data 401 corresponding to the own directory information 402 as in FIG. 5A, but an example of information of high-order 5 bits (except the least significant bit) of the number of the central processing units of 6 bits to reduce information amount will be explained in this embodiment. In other words, the central processing unit count value CNT is bits except the least significant bit of the number of the central processing units which hold the data 401 corresponding to the own directory information 402.

The directory information 402 has information except the own central processing unit as described above for reduction of the number of bits, but may also be information including the own central processing unit.

The directory information 402 in FIG. 5B is increased by 4 bits as compared with the directory information 402 in FIG. 5A and is 28 bits in total. Use of the directory information 402 in FIG. 5B improves the rate of discovering a central processing unit that is suspected to have broken down, as compared with the directory information 402 in FIG. 5A. Further, the status ST and the least significant bit of the central processing unit count value CNT are reduced in the directory information 402 in FIG.

5B with respect to the directory information 402 in FIG. 5A, but there is no problem because they can be restored from other information as will be described later.

The reason why the maximum value of the central processing unit count value CNT is not 64 that is the total number of the central processing units but 63 is that registration of the case where the own central processing unit holds the own memory is unnecessary. Whether or not the own central processing unit holds the data 401 can be determined from the state of the own secondary cache memory section 303 not from the directory information 402.

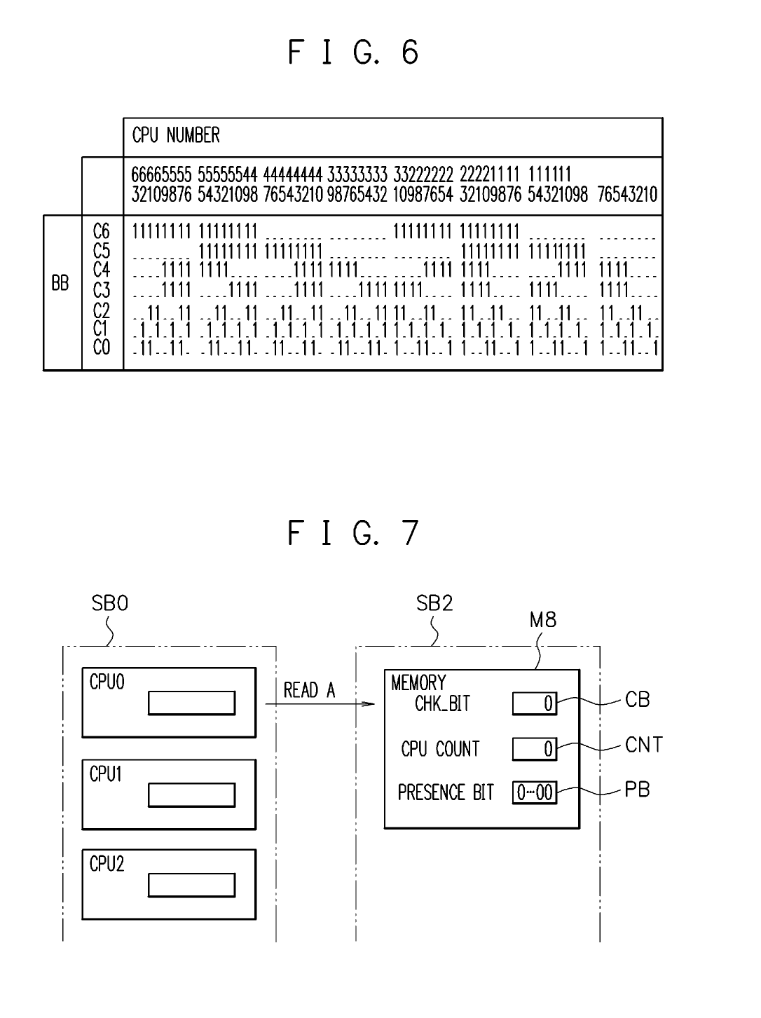

FIG. 6 is a chart illustrating the correspondence between a central processing unit number and a specific bit sequence BB. The specific bit sequence (identification information) BB is a bit sequence of specific 7 bits for identifying each central processing unit. For example, the specific bit sequence BB of the central processing unit CPU0 is “0000001” in binary number (“1” in decimal number), and the specific bit sequence BB of the central processing unit CPU1 is “0000010” in binary number (“2” in decimal number). In the specific bit sequence BB of each of central processing units CPU0 to CPU63, the number of bits having a value of 1 is an odd number. For example, the number of bits having a value of 1 of the central processing unit

CPU0 to CPU2 is one, and the number of bits having a value of 1 of the central processing unit CPU3 to CPU6 is three.

The initial value of the check bit CB in FIG. 5B is 0. When each of the own memories M0 to M63 of the central processing units CPU0 to CPU63 is accessed from other central processing units CPU0 to CPU63, each of the central processing units CPU0 to CPU63 performs an exclusive logical sum (XOR) operation on the check bit CB with the specific bit sequence BB of the central processing unit CPU0 to CPU63 which has accessed. Hereinafter, an update example of the directory information 402 in FIG. 5B will be described. First, an example where a central processing unit issues a read request for data will be exemplified referring to FIG. 7 to FIG. 12.

FIG. 7 is a chart illustrating an example of a case where the central processing unit CPU0 in the system board SB0 reads the data in the memory M8 in the other system board SB2. The system board SB0 has the central processing units CPU0 to CPU2. The system board SB2 has the central processing unit CPU8 and the memory M8 connected to the central processing unit CPU8. In the memory M8, the directory information 402 including the check bit CB, the central processing unit count value CNT, and the presence bit PB is stored. All of initial values of the check bit CB, the central processing unit count value CNT, and the presence bit PB are 0. First, the central processing unit CPU0 in the system board SB0 outputs a read request to the central processing unit CPU8 in the system board SB2 in order to read the data 401 in the memory M8.

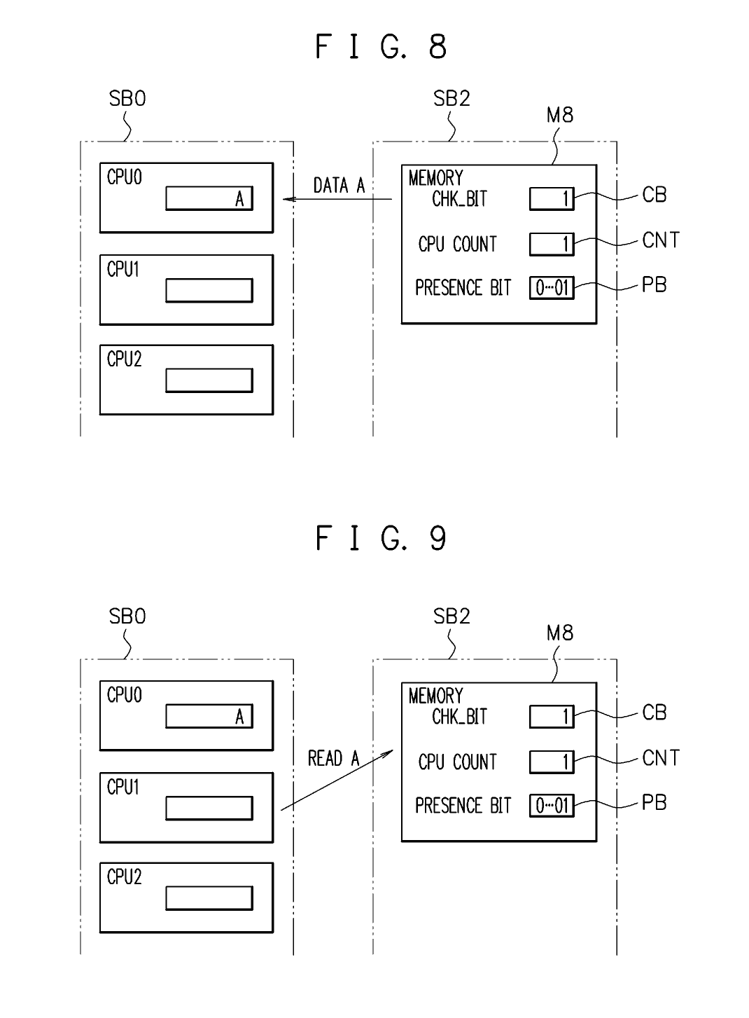

Then, as illustrated in FIG. 8, the central processing unit CPU8 in the system board SB2, in response to the above read request, reads the data 401 and the ECC information 403 in the memory M8, outputs them to the central processing unit CPU0 in the system board SB0, and updates the check bit CB, the central processing unit count value CNT, and the presence bit PB in the memory M8. More specifically, the central processing unit CPU8 in the system board SB2 performs an XOR operation on a binary number “0000000” (a decimal number “0”) of the check bit CB with a binary number “0000001” (a decimal number “1”) of the specific bit sequence BB of the central processing unit CPU0 which has issued the read request. By the XOR operation, the bits of the check bit CB corresponding to the bits of the specific bit sequence BB being 0 are not changed, whereas the bits of the check bit CB corresponding to the bit of the specific bit sequence BB being 1 is logically inverted. As a result, the check bit CB becomes a binary number “0000001” (a decimal number “1”). By referring to the check bit CB, it is found that the central processing unit CPU0 having the same specific bit sequence BB as the check bit CB holds the data 401. Further, the central processing unit CPU8 increments the central processing unit count value CNT. Thus, the central processing unit count value CNT becomes “1.” Note that though the central processing unit count value CNT does not have the least significant bit, the least significant bit can be restored by the later-described method, and therefore the central processing unit count value CNT after restoring the least significant bit will be exemplified below. Further, the central processing unit CPU8 validates a bit, in the presence bit PB, for identifying the system board SB0 including the central processing unit CPU0 which has issued the read request. For example, in the presence bit PB, the least significant bit indicates the system board SB0 and the next least significant bit indicates the system board SB1. Thus, the presence bit PB becomes “0000000000000001.”

Next, as illustrated in FIG. 9, the central processing unit CPU1 in the system board SB0 outputs a read request to the central processing unit CPU8 in the system board SB2 in order to read the data 401 in the memory M8.

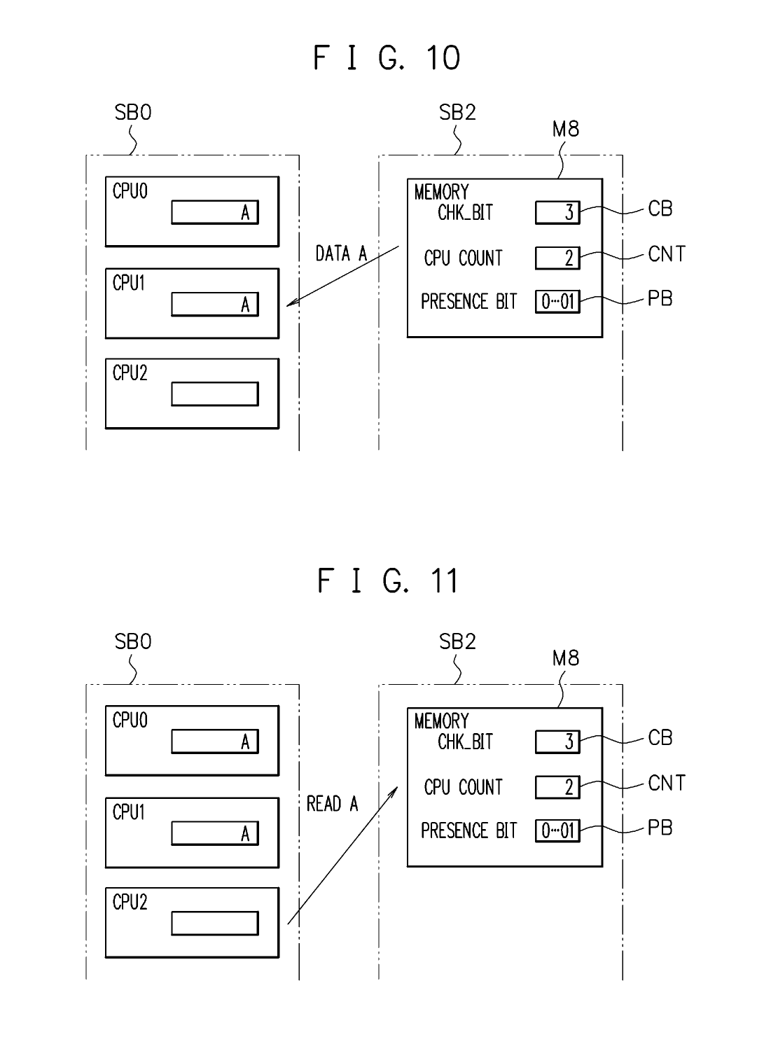

Next, as illustrated in FIG. 10, the central processing unit CPU8 in the system board SB2, in response to the above read request, reads the data 401 and the ECC information 403 in the memory M8, outputs them to the central processing unit CPU1 in the system board SB0, and updates the check bit CB, the central processing unit count value CNT, and the presence bit PB in the memory M8. More specifically, the central processing unit CPU8 performs an XOR operation on the binary number “0000001” (the decimal number “1”) of the check bit CB with a binary number “0000010” (a decimal number “2”) of the specific bit sequence BB of the central processing unit CPU1 which has issued the read request. As a result, the check bit CB becomes a binary number “0000011” (a decimal number “3”). Further, the central processing unit CPU8 increments the central processing unit count value CNT. Thus, the central processing unit count value CNT becomes “2.” Further, the central processing unit CPU8 validates a bit, in the presence bit PB, for identifying the system board SB0 including the central processing unit CPU1 which has issued the read request. Thus, the presence bit PB becomes “0000000000000001.” By referring to the check bit CB and the central processing unit count value CNT, it is found that two central processing units hold the data 401.

Next, as illustrated in FIG. 11, the central processing unit CPU2 in the system board SB0 outputs a read request to the central processing unit CPU8 in the system board SB2 in order to read the data 401 in the memory M8.

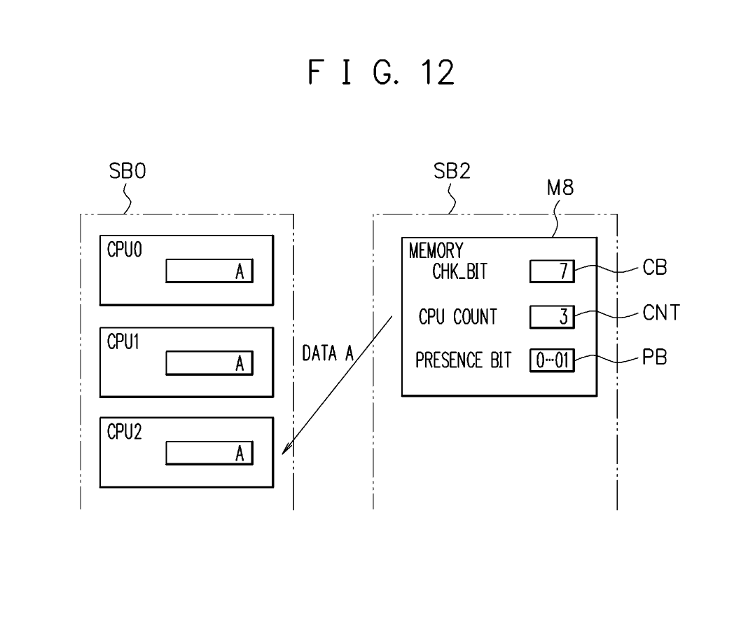

Next, as illustrated in FIG. 12, the central processing unit CPU8 in the system board SB2, in response to the above read request, reads the data 401 and the ECC information 403 in the memory M8, outputs them to the central processing unit CPU2 in the system board SB0, and updates the check bit CB, the central processing unit count value CNT, and the presence bit PB in the memory M8. More specifically, the central processing unit CPU8 performs an XOR operation on the binary number “0000011” (the decimal number “3”) of the check bit CB with a binary number “0000100” (a decimal number “4”) of the specific bit sequence BB of the central processing unit CPU2 which has issued the read request. As a result, the check bit CB becomes a binary number “0000111” (a decimal number “7”). Further, the central processing unit CPU8 increments the central processing unit count value CNT. Thus, the central processing unit count value CNT becomes “3.” Further, the central processing unit CPU8 validates a bit, in the presence bit PB, for identifying the system board SB0 including the central processing unit CPU2 which has issued the read request. Thus, the presence bit PB becomes “0000000000000001.” By referring to the check bit CB and the central processing unit count value CNT, it is found that three central processing units hold the data 401.

As described above, upon receiving the read request for the data 401 in the memory M8 corresponding to the own central processing unit CPU8 from the other central processing unit CPU0 to CPU2, the central processing unit CPU8 performs an XOR operation on the check bit CB with the specific bit sequence BB of the other central processing unit CPU0 to CPU2, increments the central processing unit count value CNT, validates the presence bit PB indicating the system board SB0 including the other central processing unit CPU0 to CPU2, and outputs the data 401 in the memory M8 to the other central processing unit CPU0 to CPU2.

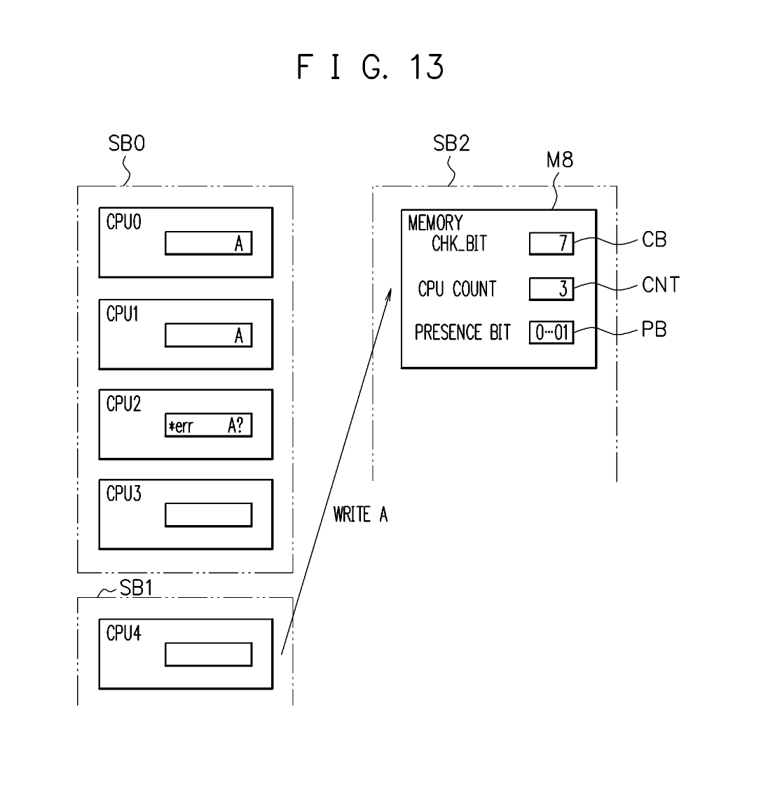

Next, an example where the central processing unit CPU4 issues an acquisition request for an exclusive right for writing data will be described referring to FIG. 13 to FIG. 18. A case where one central processing unit CPU2 has broken down will be described here as an example.

As illustrated in FIG. 13 subsequent to FIG. 12, the central processing unit CPU4 in the system board SB1 outputs an exclusive right acquisition request to the central processing unit CPU8 in the system board SB2 in order to write the data 401 in the memory M8.

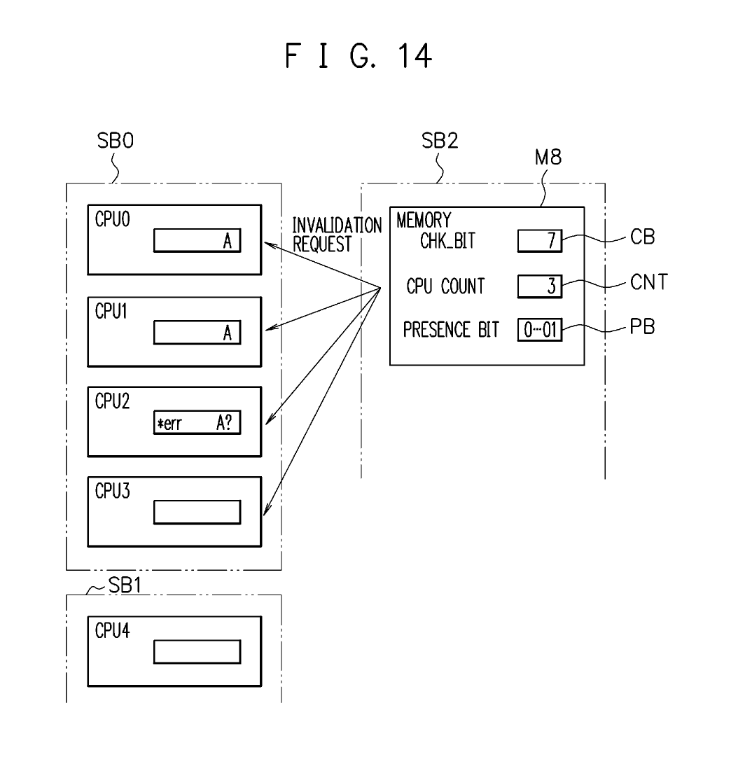

Next, as illustrated in FIG. 14, the central processing unit CPU8 in the system board SB2, in response to the above exclusive right acquisition request, outputs an invalidation request for the data 401 to all of the central processing units CPU0 to CPU3 in the system board SB0 for which the presence bit PB is valid.

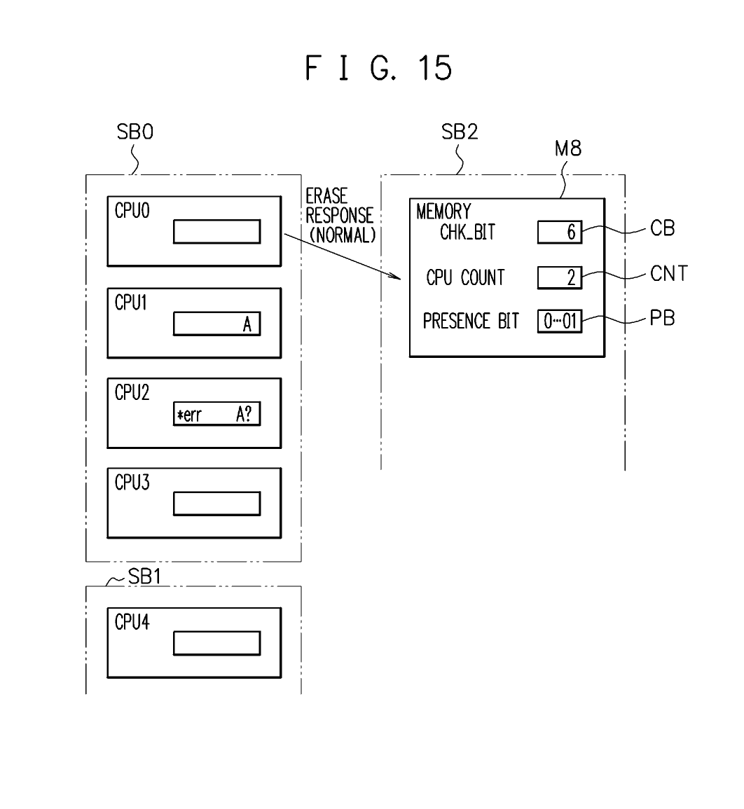

Next, as illustrated in FIG. 15, the central processing unit CPU0 in the system board SB0, in response to the above invalidation request, erases the data 401 held in the central processing unit CPU0, and outputs a normal data erase response as an invalidation response to the central processing unit CPU8 in the system board SB2. Upon receiving input of the data erase response as the invalidation response, the central processing unit CPU8 updates the check bit CB and the central processing unit count value CNT in the memory M8. More specifically, the central processing unit CPU8 performs an XOR operation on the binary number “0000111” of the check bit CB with the binary number “0000001” of the specific bit sequence BB of the central processing unit CPU0 in the system board SB0. For example, the binary number “0000001” of the specific bit sequence BB of the central processing unit CPU0 in the system board SB0 accompanies the invalidation response from the CPU0. Thus, the check bit CB becomes a binary number “0000110” (a decimal number “6”). Further, the central processing unit CPU8 decrements the central processing unit count value CNT. Thus, the central processing unit count value CNT becomes “2.”

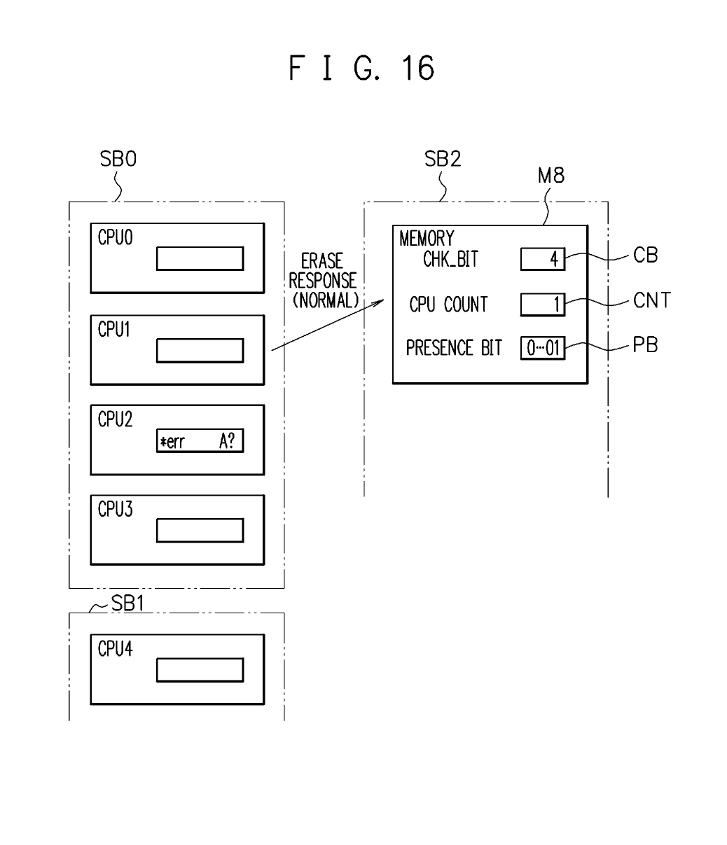

Next, as illustrated in FIG. 16, the central processing unit CPU1 in the system board SB0, in response to the above invalidation request, erases the data 401 held in the central processing unit CPU1, and outputs a normal data erase response as an invalidation response to the central processing unit CPU8 in the system board SB2. Upon receiving input of the data erase response as the invalidation response, the central processing unit CPU8 updates the check bit CB and the central processing unit count value CNT in the memory M8. More specifically, the central processing unit CPU8 performs an XOR operation on the binary number “0000110” of the check bit CB with the binary number “0000010” of the specific bit sequence BB of the central processing unit CPU1 in the system board SB0. For example, the binary number “0000010” of the specific bit sequence BB of the central processing unit CPU1 in the system board SB0 accompanies the invalidation response from the CPU1. Thus, the check bit CB becomes a binary number “0000100” (a decimal number “4”). Further, the central processing unit CPU8 decrements the central processing unit count value CNT. Thus, the central processing unit count value CNT becomes “1.”

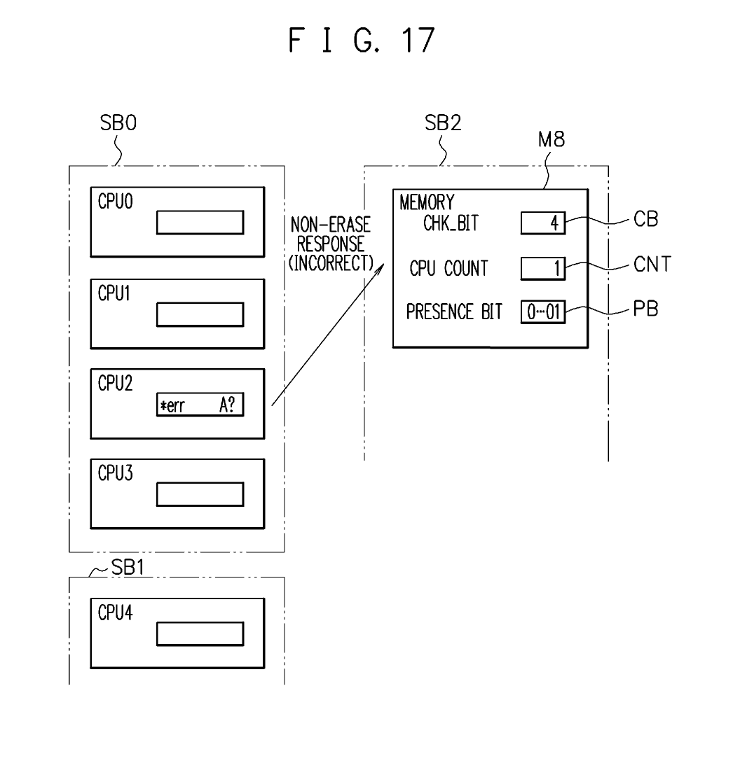

Next, as illustrated in FIG. 17, a case where the central processing unit CPU2 in the system board SB0 has broken down will be described. In response to the above invalidation request, the central processing unit CPU2 is supposed to erase the data 401 held in the central processing unit CPU2, and output a data erase response as an invalidation response to the central processing unit CPU8 in the system board SB2. However, it is assumed that because of breakdown, the central processing unit CPU2 has erroneously outputted an incorrect data non-erase response as an invalidation response to the central processing unit CPU8 in the system board SB2. Upon receiving input of the data non-erase response as the invalidation response, the central processing unit CPU8 does not update but holds the check bit CB and the central processing unit count value CNT in the memory M8.

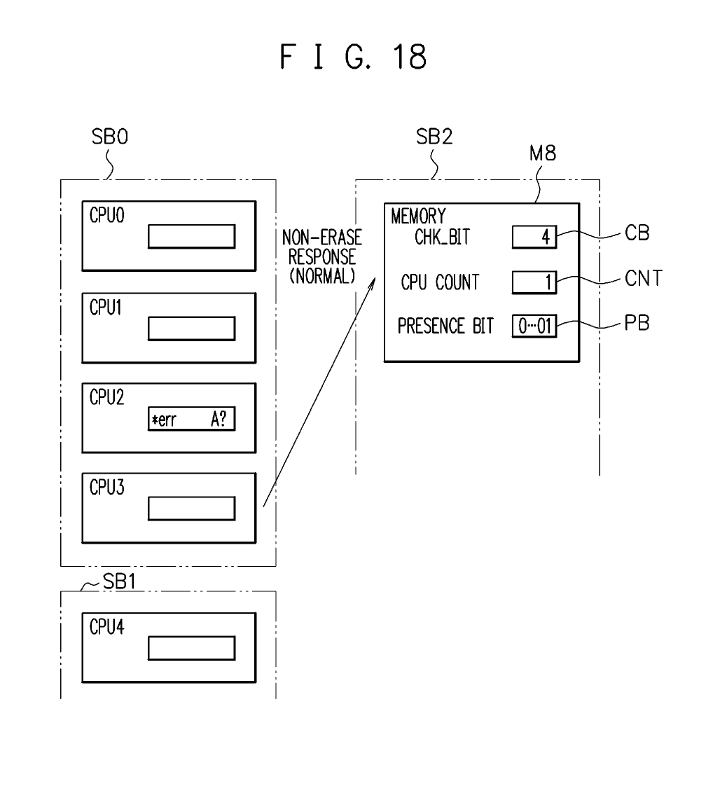

Next, as illustrated in FIG. 18, the central processing unit CPU3, in response to the above invalidation request, outputs a normal data non-erase response as an invalidation response to the central processing unit CPU8 in the system board SB2, because it does not hold the data 401. Upon receiving input of the data non-erase response as the invalidation response, the central processing unit CPU8 does not update but holds the check bit CB and the central processing unit count value CNT in the memory M8.

After the above responses are inputted from all of the central processing units CPU0 to CPU3 in the system board SB0, if all of the central processing units CPU0 to CPU3 are normal, both the check bit CB and the central processing unit count value CNT become “0.” Accordingly, if both the check bit CB and the central processing unit count value CNT are “0,” the central processing unit CPU8 can recognize that all of the central processing units CPU0 to CPU3 in the system board SB0 are normal and normal processing has been performed. Then, the central processing unit CPU4 has acquired the exclusive right and therefore can write data into the memory M8. Through the writing, the central processing unit CPU8 updates the check bit CB and the central processing unit count value CNT in the memory M8. The check bit CB becomes a binary number “0110001,” the central processing unit count value CNT becomes “1,” and all bits of the presence bit PB are kept 0.

In the case of FIG. 18, however, since the check bit CB and the central processing unit count value CNT are not “0,” the central processing unit CPU8 can suspect breakdown of any one of the central processing units CPU0 to CPU3. More specifically, since the check bit CB is the binary number “0000100” (the decimal number “4”) and the central processing unit count value CNT is “1,” breakdown of one central processing unit CPU3 can be suspected. Accordingly, the central processing unit CPU8 can determine that two points, that is, the own central processing unit CPU8 and the other central processing unit CPU3 are suspected to have broken down. By detecting the breakdown as described above, a malfunction thereafter can be prevented. If the broken central processing unit can be identified, restoration becomes possible, for example, by separating the broken central processing unit from the multiprocessor system, resulting in improved reliability of the whole multiprocessor system.

As described above, upon receiving the acquisition request for the exclusive right for writing the data 401 in the memory M8 corresponding to the own central processing unit CPU8 from the other central processing unit CPU4, the central processing unit CPU8 outputs the invalidation request to the plurality of central processing units CPU0 to CPU3 in the system board SB0 for which the presence bit PB is valid and, upon receiving in response thereto input of the data erase responses as the invalidation responses from the central processing units CPU0 and CPU1 in the system board SB0, the central processing unit CPU8 performs an XOR operation on the check bit CB with the specific bit sequences BB of the central processing units CPU0 and CPU1 in the system board SB0, and decrements the central processing unit count value CNT. For example, the specific bit sequences BB of the central processing units CPU0 and CPU1 in the system board SB0 accompany the invalidation responses from the CPU0 and CPU1.

After receiving the acquisition request for the exclusive right for writing the data 401 in the memory M8 corresponding to the own central processing unit CPU8 from the other central processing unit CPU4 and updating the check bit CB and the central processing unit count value CNT, if the central processing unit count value CNT is 1, the central processing unit CPU8 can determine that the central processing unit CPU2 indicated by the check bit CB or the own central processing unit CPU8 has broken down.

Further, after receiving the acquisition request for the exclusive right for writing the data 401 in the memory M8 corresponding to the own central processing unit CPU8 from the other central processing unit CPU4 and updating the check bit CB and the central processing unit count value CNT, if the central processing unit count value CNT is 2 or more, the central processing unit CPU8 can determine that a plurality of central processing units in the system board SB0 have broken down.

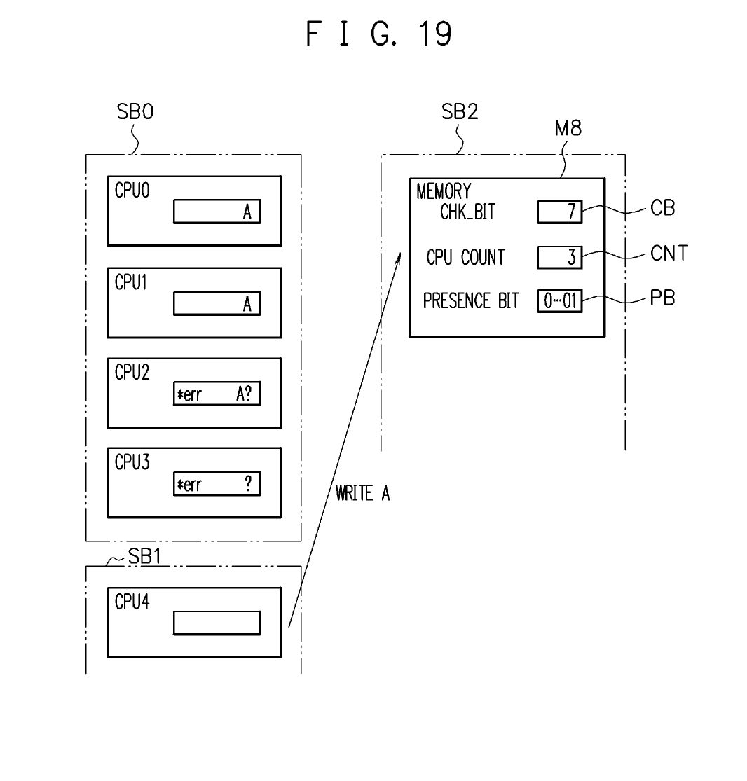

Next, another example where the central processing unit CPU4 issues the acquisition request for the exclusive right for writing data will be described referring to FIG. 19 to FIG. 24. A case where two central processing units CPU2 and CPU3 have broken down will be described here as an example.

As illustrated in FIG. 19 subsequent to FIG. 12, the central processing unit CPU4 in the system board SB1 outputs an exclusive right acquisition request to the central processing unit CPU8 in the system board SB2 in order to write the data 401 in the memory M8.

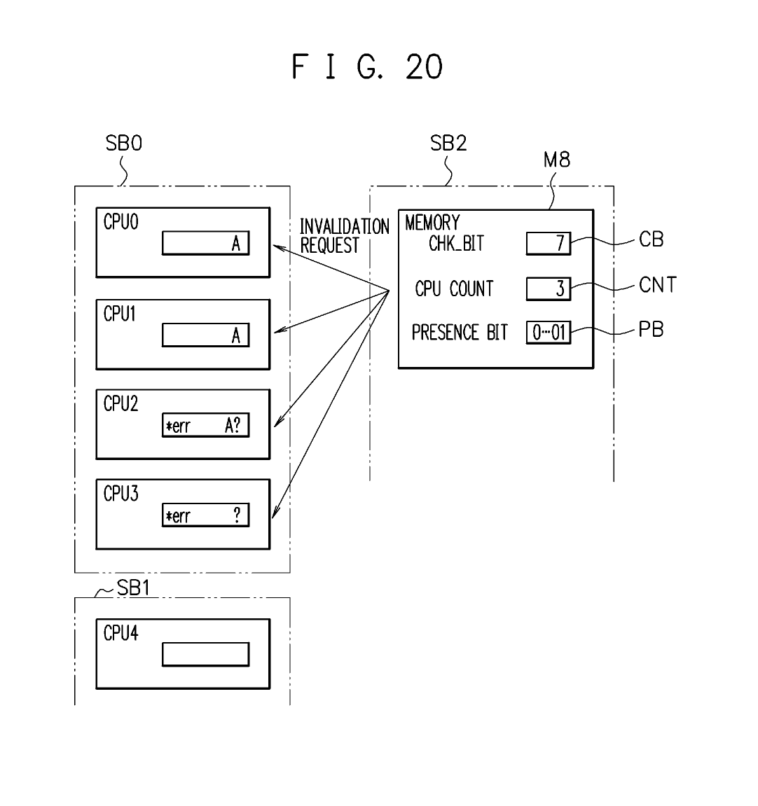

Next, as illustrated in FIG. 20, the central processing unit CPU8 in the system board SB2, in response to the above exclusive right acquisition request, outputs an invalidation request for the data 401 to all of the central processing units CPU0 to CPU3 in the system board SB0 for which the presence bit PB is valid.

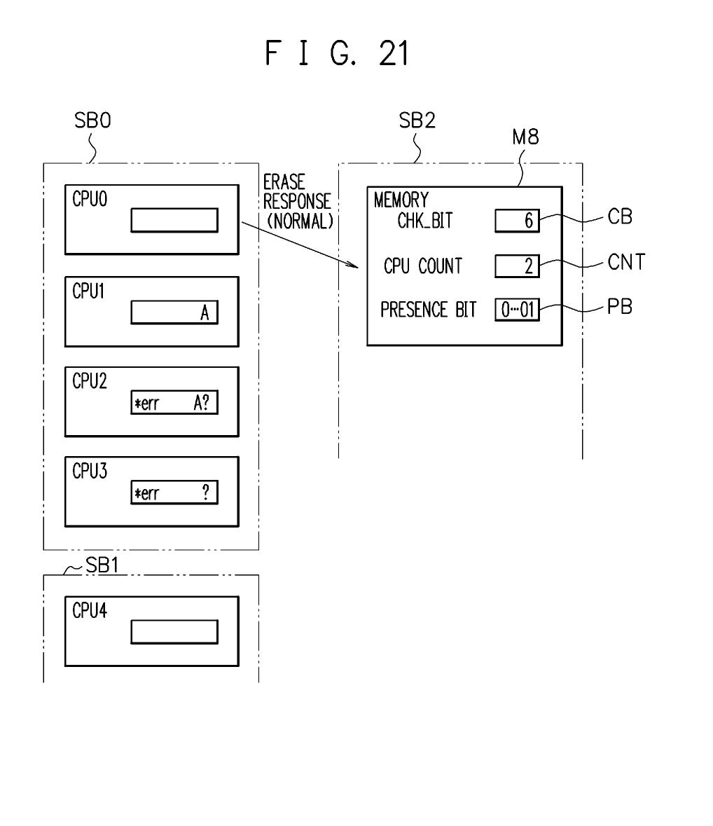

Next, as illustrated in FIG. 21, the central processing unit CPU0 in the system board SB0, in response to the above invalidation request, erases the data 401 held in the central processing unit CPU0, and outputs a normal data erase response as an invalidation response to the central processing unit CPU8 in the system board SB2. Upon receiving input of the data erase response as the invalidation response, the central processing unit CPU8 updates the check bit CB and the central processing unit count value CNT in the memory M8. More specifically, the central processing unit CPU8 performs an XOR operation on the binary number “0000111” of the check bit CB with the binary number “0000001” of the specific bit sequence BB of the central processing unit CPU0 in the system board SB0. For example, the specific bit sequence BB of the central processing unit CPU0 in the system board SB0 accompanies the invalidation response from the CPU0. Thus, the check bit CB becomes a binary number “0000110” (a decimal number “6”). Further, the central processing unit CPU8 decrements the central processing unit count value CNT. Thus, the central processing unit count value CNT becomes “2.”

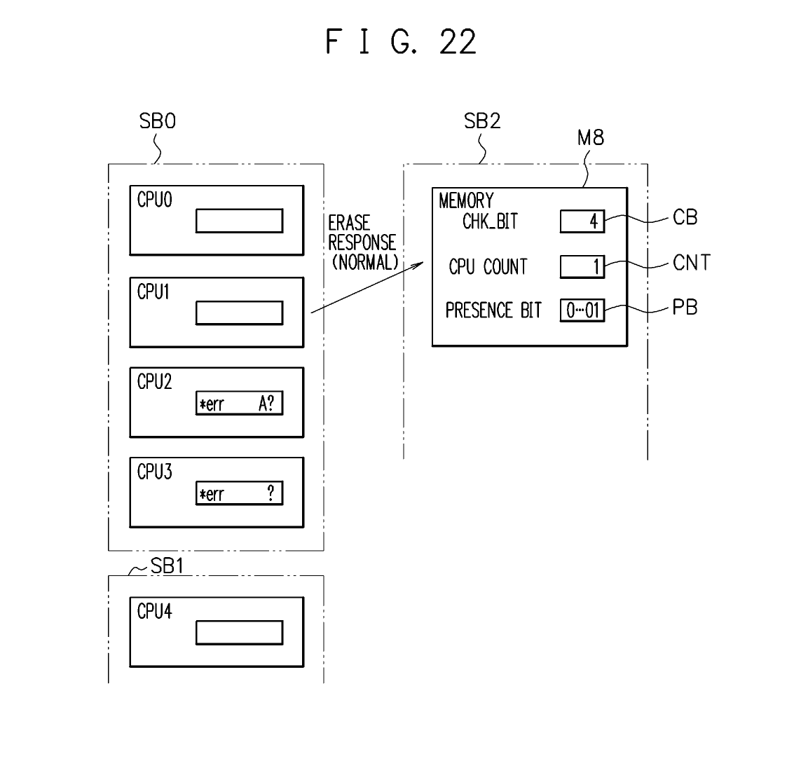

Next, as illustrated in FIG. 22, the central processing unit CPU1 in the system board SB0, in response to the above invalidation request, erases the data 401 held in the central processing unit CPU1, and outputs a normal data erase response as an invalidation response to the central processing unit CPU8 in the system board SB2. Upon receiving input of the data erase response as the invalidation response, the central processing unit CPU8 updates the check bit CB and the central processing unit count value CNT in the memory M8. More specifically, the central processing unit CPU8 performs an XOR operation on the binary number “0000110” of the check bit CB with the binary number “0000010” of the specific bit sequence BB of the central processing unit CPU1 in the system board SB0. For example, the specific bit sequence BB of the central processing unit CPU1 in the system board SB0 accompanies the invalidation response from the CPU1. Thus, the check bit CB becomes a binary number “0000100” (a decimal number “4”). Further, the central processing unit CPU8 decrements the central processing unit count value CNT. Thus, the central processing unit count value CNT becomes “1.”

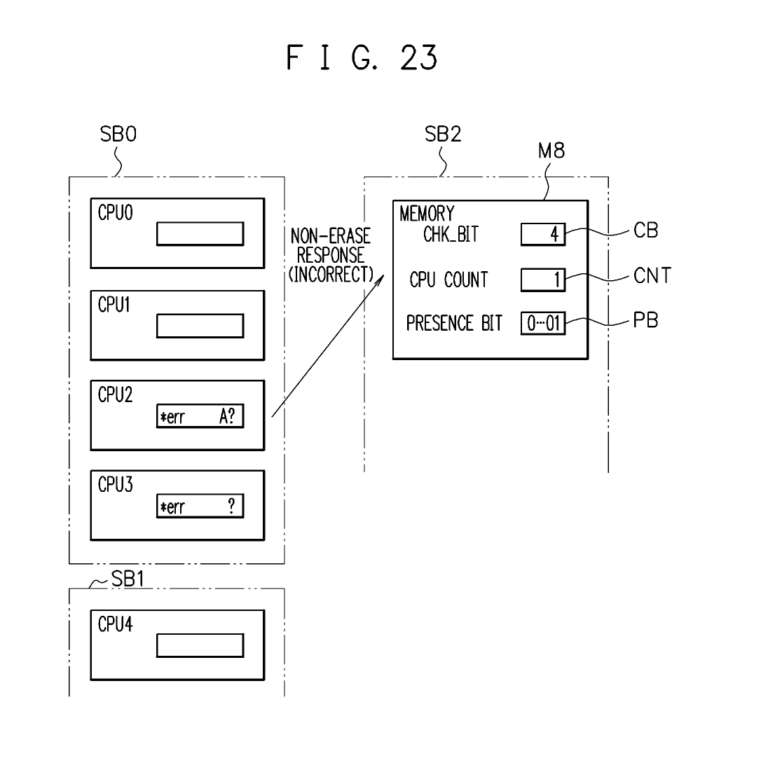

Next, as illustrated in FIG. 23, a case where the central processing unit CPU2 in the system board SB0 has broken down will be described. In response to the above invalidation request, the central processing unit CPU2 is supposed to erase the data 401 held in the central processing unit CPU2, and output a data erase response as an invalidation response to the central processing unit CPU8 in the system board SB2. However, it is assumed that because of breakdown, the central processing unit CPU2 has erroneously outputted an incorrect data non-erase response as an invalidation response to the central processing unit CPU8 in the system board SB2. Upon receiving input of the data non-erase response as the invalidation response, the central processing unit CPU8 does not update but holds the check bit CB and the central processing unit count value CNT in the memory M8.

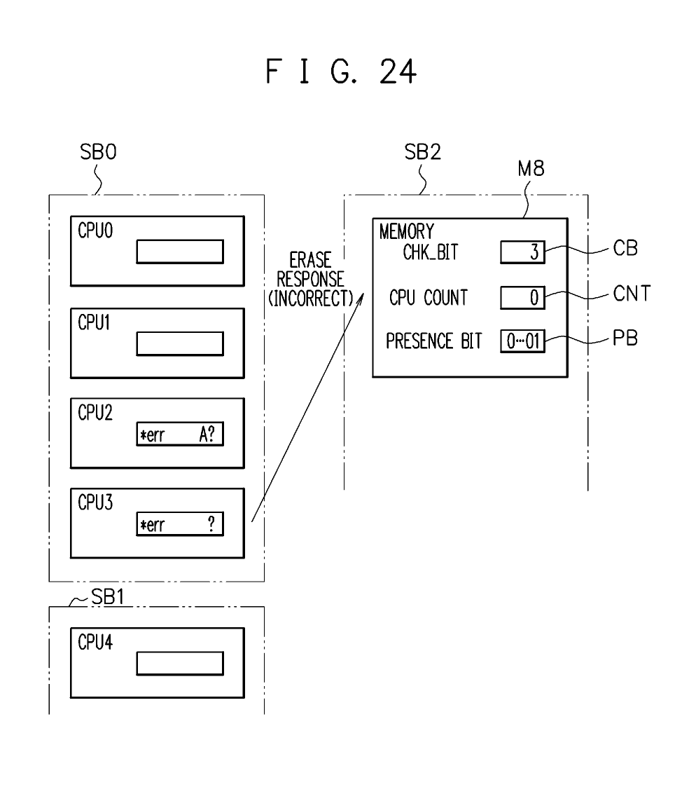

Next, as illustrated in FIG. 24, a case where the central processing unit CPU3 in the system board SB0 has broken down will be described. In response to the above invalidation request, the central processing unit CPU3 is supposed to output a data non-erase response as an invalidation response to the central processing unit CPU8 in the system board SB2, because it does not hold the data 401. However, it is assumed that because of breakdown, the central processing unit CPU3 has erroneously outputted an incorrect data erase response as an invalidation response to the central processing unit CPU8 in the system board SB2. Upon receiving input of the data erase response as the invalidation response, the central processing unit CPU8 updates the check bit CB and the central processing unit count value CNT in the memory M8. More specifically, the central processing unit CPU8 performs an XOR operation on the binary number “0000100” of the check bit CB with the binary number “0000111” of the specific bit sequence BB of the central processing unit CPU3 in the system board SB0. For example, the binary number “0000111” of the specific bit sequence BB of the central processing unit CPU3 in the system board SB0 accompanies the invalidation response from the CPU3. Thus, the check bit CB becomes a binary number “0000011” (a decimal number “3”). Further, the central processing unit CPU8 decrements the central processing unit count value CNT. Thus, the central processing unit count value CNT becomes “0.”

After the above responses are inputted from all of the central processing units CPU0 to CPU3 in the system board SB0, if all of the central processing units CPU0 to CPU3 are normal, both the check bit CB and the central processing unit count value CNT become “0” and all bits of the presence bit PB are cleared. Accordingly, if both the check bit CB and the central processing unit count value CNT are “0,” the central processing unit CPU8 can recognize that all of the central processing units CPU0 to CPU3 in the system board SB0 are normal and normal processing has been performed.

In the case of FIG. 24, however, since the central processing unit count value CNT “0” but the check bit CB is not “0,” the central processing unit CPU8 can suspect breakdown of a plurality of central processing units. As described above, the breakdown of the plurality of central processing units can be detected, and a malfunction thereafter can be prevented.

The directory information 402 in FIG. 5B is made by omitting the status ST in FIG. 5A for reduction of the information amount, and it will be discussed below that the omitted information can be reconstructed.

“00” of the status ST is information indicating that the data 401 is not held in the other central processing units (except the own central processing unit). In the case where the central processing unit count value CNT[5:1] is “00000,” the check bit CB is “0000000,” and all bits of the presence bit PB are 0, the status ST can be determined to be “00.”

“10” of the status ST indicates that the data 401 is in a shared state and the data 401 is held in the other central processing units. In the case where the central processing unit count value CNT[5:1] is an arbitrary value, and the check bit CB is an arbitrary value, and all bits of the presence bit PB are not 0, the status ST can be determined to be “10.”

“11” of the status ST is information indicating that the data 401 is held in the other central processing unit having the exclusive right for the data 401. In the case where the central processing unit count value CNT[5:1] is “00000,” the check bit CB is not “0000000,” and all bits of the presence bit PB are 0, the status ST can be determined to be “11.”

As for the directory information 402 in FIG. 5B, the least significant bit CNT[0] of the central processing unit count value CNT is omitted to reduce the information amount. As for the central processing unit count value CNT, the bit CNT[5:1] made by excluding the least significant bit CNT[0] from the number of central processing units CNT[5:0] holding the data 401 corresponding to the own directory information 402 is stored in the memory.

The least significant bit CNT[0] of the number of central processing units holding the data 401 corresponding to the own directory information 402 is calculated by an XOR operation on all bits of the check bit CB. The value calculated by the XOR operation on all bits of the check bit CB becomes 1 when the number of central processing units CNT[5:0] holding the data 401 corresponding to the own directory information 402 is an odd number, and becomes 0 when the number of central processing units CNT[5:0] holding the data 401 corresponding to the own directory information 402 is an even number. In other words, the least significant bit CNT[0] of the number of central processing units holding the data 401 becomes “1” when the value calculated by the XOR operation on all bits of the check bit CB is 1, and becomes “0” when the value calculated by the XOR operation on all bits of the check bit CB is 0. In the specific bit sequence BB of each of the central processing units in FIG. 6, the number of bits having a value of 1 is an odd number, and therefore the least significant bit CNT[0] can be reproduced on the basis of the check bit CB.

For example, in the case of FIG. 9, since the check bit CB is “0000001” and the value calculated by the XOR operation on all bits of the check bit CB becomes “1,” the least significant bit CNT[0] becomes “1.” Thus, the central processing unit count value CNT[5:0] becomes “1.”

Further, in the case of FIG. 10, since the check bit CB is “0000011” and the value calculated by the XOR operation on all bits of the check bit CB becomes “0,” the least significant bit CNT[0] becomes “0.” Thus, the central processing unit count value CNT[5:0] becomes “2.”

Further, in the case of FIG. 12, since the check bit CB is “0000111” and the value calculated by the XOR operation on all bits of the check bit CB becomes “1,” the least significant bit CNT[0] becomes “1. ” Thus, the central processing unit count value CNT[5:0] becomes “3.”

Next, a case where the block of the data 401 managed by the central processing unit CPU2 is shared among all of the central processing units and an error has occurred in the central processing unit CPU0 when the central processing unit CPU1 has tried to rewrite, and the central processing unit CPU1 has erroneously reported the situation as a data non-erase response as an invalidation response, will be discussed.

The central processing unit CPU1 executes a write instruction to an address A. The central processing unit CPU1 does not have the exclusive right and therefore requests for an exclusive right acquisition request to the central processing unit CPU2 that is the management source of the memory M2 via the router 201. The central processing unit CPU2 accesses the memory M2 and acquires the data block 401 at the address A and the directory information 402 and, as a result of analysis of the directory information 402, finds that the system boards SB0 to SB15 hold the data. Whether the central processing unit CPU2 has the data or not is found by searching the own cache memory. The central processing unit CPU2 issues an invalidation request to the central processing units, including the own cache memory.

Each of the central processing units searches its own cache memory and invalidates (erases) the data and reports a data erase response as an invalidation response to the central processing unit CPU2 if it holds the data, and reports a data non-erase response as an invalidation response to the central processing unit CPU2 if it does not hold the data. The central processing unit CPU2 performs an XOR operation on the specific bit sequence BB of the central processing unit and the check bit CB when receiving the report of the data erase response as the invalidation response, and performs nothing when receiving the report of the data non-erase response.

By calculation based on the reports from all of the central processing units in the above manner, the check bit CB is supposed to return to “0.” In this case, the report that is supposed to be the data erase response as the invalidation response from the central processing unit CPU0 is the data non-erase response, and therefore the check bit CB becomes “1” which discovers that the central processing unit CPU0 has made an incorrect report.

In principle, it is enough to be able to assign a specific bit sequence BB to each central processing unit, and therefore it is only necessary that the number of bits required for the check bit CB is at least log ₂ (the number of central processing units) bits. In this embodiment, setting the number of bits to 7 bits although log ₂(64)=6 makes it possible to detect the incorrect reports from two central processing units as illustrated in FIG. 19 to FIG. 24. As described above, the number of bits of the check bit CB only needs to be decided according to the required inspection level and is not limited to 7 bits.

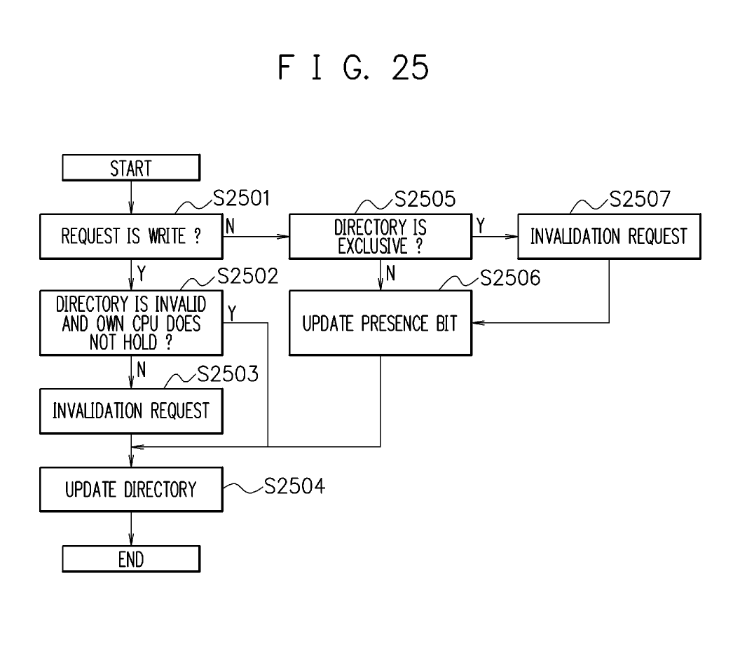

FIG. 25 is a flowchart illustrating an example of update processing on the directory information 402 when a read request or a write request (an exclusive right acquisition request) is issued from a central processing unit. At Step S2501, the central processing unit CPU8 checks whether the request inputted from the other central processing unit is an exclusive right acquisition request for write or a read request. The central processing unit CPU8 proceeds to Step S2505 if it is the read request, and proceeds to Step S2502 if it is the exclusive right acquisition request.

At Step S2502, the central processing unit CPU8 proceeds to Step S2504 when the status ST is “00” (Invalid) and the own central processing unit CPU8 does not hold the data 401 in the memory M8, and otherwise, proceeds to Step S2503. The status ST is found on the basis of the directory information 402 as described above.

At Step S2503, the central processing unit CPU8 outputs an invalidation request to all of the central processing units CPU0 to CPU3 in the system board SB0 for which the presence bit PB is valid as illustrated in FIG. 14. Thereafter, the central processing unit CPU8 proceeds to Step S2504.

At Step S2504, the central processing unit

CPU8 updates the directory information 402 including the check bit CB and the central processing unit count value CNT. Thus, in the directory information 402, the check bit CB becomes the specific bit sequence BB of the central processing unit being the request source, the central processing unit count value CNT[5:1] becomes “0,” and the presence bits PB becomes “0,” to indicate a state that the central processing unit being the request source solely holds the exclusive right.

At Step S2505, the central processing unit CPU8 determines whether the status ST is “11” (Exclusive) or not on the basis of the directory information 402 in the memory M8. “11” of the status ST means that the other central processing unit has the exclusive right. The central processing unit CPU8 proceeds to Step S2507 if the status ST is “11,” and proceeds to Step S2506 if the status ST is not “11.”

At Step S2507, the central processing unit CPU8 outputs an invalidation request to the central processing unit having the exclusive right and thereby causes the central processing unit to erase data. Then, the central processing unit CPU8 proceeds to Step S2506.

At Step S2506, the central processing unit CPU8 updates the presence bit PB in the memory M8. Then, the central processing unit CPU8 proceeds to Step S2504.

At Step S2504, the central processing unit CPU8 updates the directory information 402 including the check bit CB and the central processing unit count value CNT in the memory M8 as illustrated in FIG. 8, whereby the data holding state of the central processing unit being the request source is added.

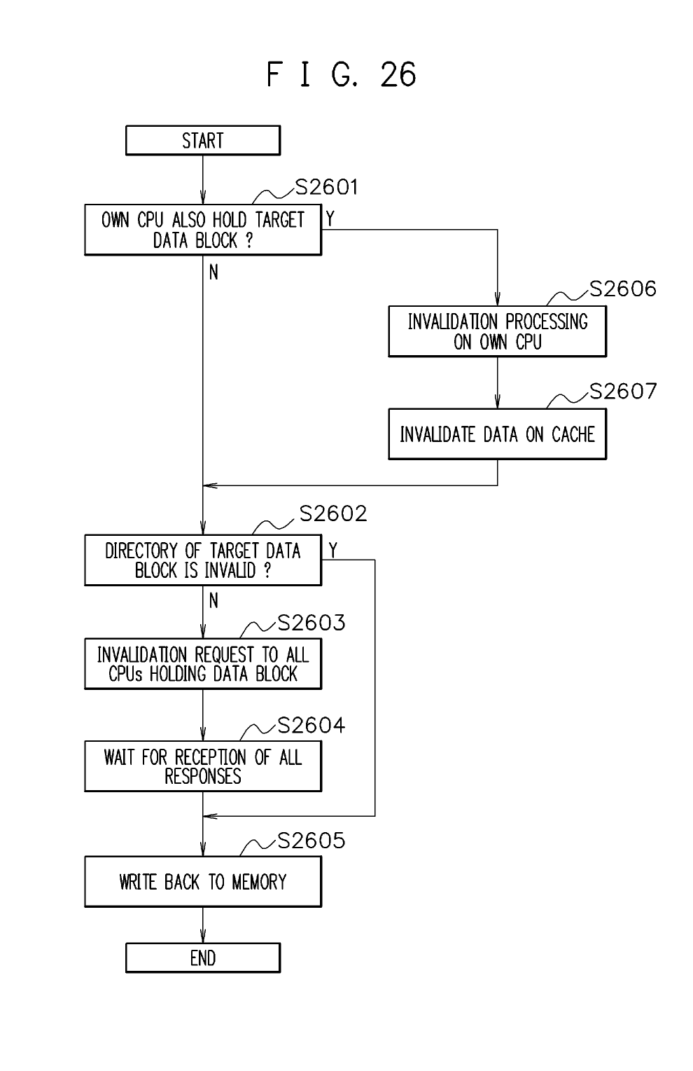

FIG. 26 is a flowchart illustrating a processing example of the invalidation request in FIG. 25. At Step S2601, the central processing unit CPU8 checks whether the own central processing unit CPU8 holds the block of the target data 401. Since whether or not the central processing unit CPU8 being the management source of the memory M8 holds the data cannot be found from the directory information 402, the central processing unit CPU8 needs to inspect its own cache memory and perform invalidation if it holds the data. The central processing unit CPU8 proceeds to Step S2606 if it holds the block of the data 401, and proceeds to Step S2602 if it does not hold the block of the data 401.

At Step S2606, the central processing unit CPU8 performs invalidation processing on the data in the own the central processing unit CPU8. Next, at Step S2607, the central processing unit CPU8 invalidates the data on the cache memory in the own central processing unit CPU8 by deleting it. Then, the central processing unit CPU8 proceeds to Step S2602.

At Step S2602, the central processing unit CPU8 determines whether the status ST is “00” (Invalid) or not on the basis of the directory information 402 in the block of the target data 401. The central processing unit CPU8 proceeds to Step S2603 when the status ST is not “00,” and proceeds to Step S2605 when the status ST is “00.”

At Step S2603, the central processing unit CPU8 outputs an invalidation request to all of the central processing units CPU0 to CPU3 in the system board SB0 which hold the data block on the basis of the presence bit PB as illustrated in FIG. 14.

Next, at Step S2604, the central processing unit CPU8 waits for reception of a data erase response or a data non-erase response from all of the central processing units CPU0 to CPU3.

Next, at Step S2605, the central processing unit CPU8 updates the directory information 402 on the secondary cache memory section 303, and writes the updated directory information 402 back to the memory M8. Then, the central processing unit CPU8 ends the processing. If the multiprocessor system normally operates, there is no central processing unit having the block of the data 401 after the invalidation processing.

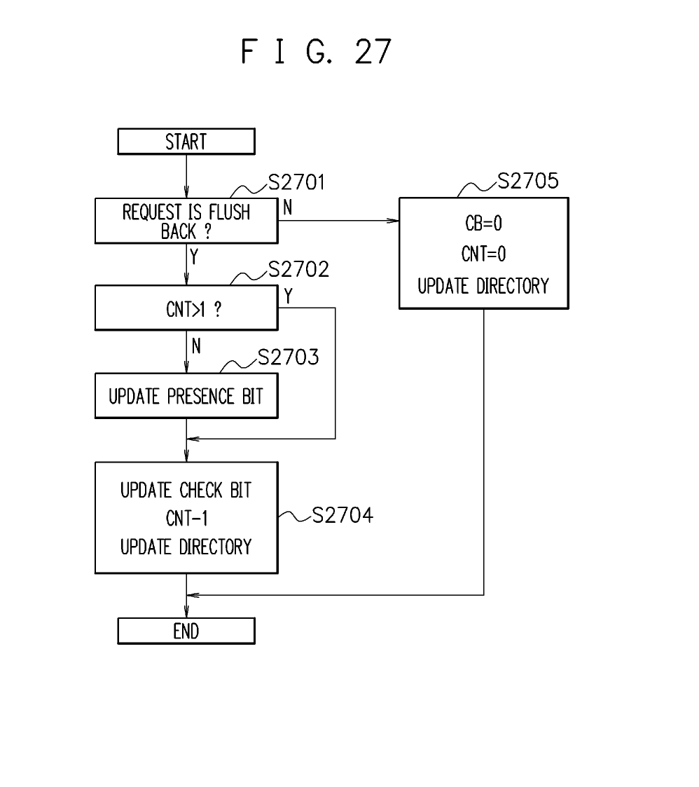

FIG. 27 is a flowchart illustrating an example of update processing on the directory information 402 in processing of write back or flush back. The write back or flush back is the processing for the block of the data 401 flushed out in cache replacement of the secondary cache memory section 303, and means release of data holding. The write back is the processing of, in the case where the data 401 on the cache memory in the central processing unit CPU8 is changed and there is a dirty flag, writing the changed data 401 back to the memory M8. The flush back is the processing of, in the case where there is no change in the data 401 on the cache memory in the central processing unit CPU8 and there is no dirty flag, not changing the data 401 but updating only the directory information 402, and writing them back to the memory M8.

At Step S2701, the central processing unit CPU8 checks whether or not the request is the flush back or the write back. The central processing unit CPU8 proceeds to Step S2702 if the request is the flush back, and proceeds to Step S2705 if the request is the write back.

At Step S2705, in the write back, for example, the central processing unit CPU8 holding the data has the exclusive right, so that the central processing unit CPU8 sets the check bit to “0,” sets the central processing unit count value CNT to “0,” and writes the updated data 401 and directory information 402 back to the memory M8. In the updated directory information 402, the status ST is “00” (Invalid).

At Step S2702, the central processing unit CPU8 checks whether the central processing unit count value CNT is greater than 1 or not. The central processing unit CPU8 proceeds to Step S2704 if it is greater than 1 because the other central processing unit holds the data, and proceeds to Step S2703 if it is 1 or less.

At Step S2703, the central processing unit CPU8 clears the presence bit PB because the other central processing unit does not hold the data. Then, the central processing unit CPU8 proceeds to Step S2704.

At Step S2704, the central processing unit CPU8 updates the check bit CB, decrements the central processing unit count value CNT, and writes the updated directory information 402 back to the memory M8.

As described above, according to this embodiment, it is possible to identify a central processing unit that is suspected to have broken down on the basis of less directory information 402 and enhance the reliability.

Note that the above-described embodiment merely illustrates a concrete example of implementing the present embodiment, and the technical scope of the present embodiment is not to be construed in a restrictive manner by these embodiment. That is, the present embodiment may be implemented in various forms without departing from the technical spirit or main features thereof.

It is possible to identify a processor that is suspected to have broken down on the basis of less directory information and enhance the reliability.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising a plurality of mutually connected system boards,
wherein each of the plurality of mutually connected system boards comprises:
a plurality of processors; and
a plurality of memories each of which stores data and directory information corresponding to the data, and corresponds to any one of the processors, and
wherein each of the plurality of processors, upon receiving a read request for data stored in a memory corresponding to the own processor from another processor, performs an exclusive logical sum operation on identification information included in the read request and identifying the another processor and a check bit included in the directory information and identifying a processor which holds target data of the read request, increments a count value included in the directory information and indicating the number of processors which hold the target data, sets presence information included in the directory information and indicating a system board which includes the another processor, and outputs the target data to the another processor which has issued the read request.

2. The information processing apparatus according to claim 1,
wherein each of the plurality of processors, upon receiving an acquisition request for an exclusive right for writing the data stored in the memory corresponding to the own processor from another processor, outputs an invalidation request for held data to all of the processors in a system board corresponding to the presence bit and, upon receiving input of an invalidation response of the held data from any one of the processors in the system board corresponding to the presence bit in response to the invalidation request, performs an exclusive logical sum operation on identification information of the processor which has made the invalidation response and the check bit, and decrements the count value.

3. The information processing apparatus according to claim 2,
wherein the each of the plurality of processors, after receiving the acquisition request for the exclusive right for writing the data stored in the memory corresponding to the own processor from the another processor and updating the check bit and the count value and if the count value is other than 0, determines that any one of the processors included in the system board has broken down.

4. The information processing apparatus according to claim 2,
wherein the each of the plurality of processors, after receiving the acquisition request for the exclusive right for writing the data stored in the memory corresponding to the own processor from the another processor and updating the check bit and the count value and if the count value is 1, determines that the processor corresponding to the check bit or the own processor has broken down.

5. The information processing apparatus according to claim 2,
wherein the each of the plurality of processors, after receiving the acquisition request for the exclusive right for writing the data in the memory corresponding to the own processor from the another processor and updating the check bit and the count value and if the check bit is other than 0, determines that any one of the processors included in a system board corresponding to the own processor has broken down.

6. The information processing apparatus according to claim 1,
wherein as the count value, bits except a least significant bit of a binary number indicating the number of processors which hold the data corresponding to the directory information are stored in the memory, and
wherein the least significant bit of the binary number is calculated by performing an exclusive logical sum operation on all bits of the check bit.

7. The information processing apparatus according to claim 1,
wherein when the identification information is expressed in binary number, the number of bits having a value of 1 is an odd number.

8. A control method of an information processing apparatus comprising a plurality of mutually connected system boards comprising memories each of which stores data and directory information corresponding to the data, the control method, comprising:
upon receiving a read request for data stored in a memory corresponding to the own processor from another processor, performing an exclusive logical sum operation on identification information included in the read request and identifying the another processor and a check bit included in the directory information and identifying a processor which holds target data of the read request;
incrementing a count value included in the directory information and indicating the number of processors which hold the target data;
setting presence information included in the directory information and indicating a system board which includes the another processor; and
outputting the target data to the another processor.
